(19) United States
(12) Patent Application Publication
(10) Pub. No.: US 2025/0321534 A1
(43) Pub. Date: Oct. 16, 2025

(54) CONTAINER AND INSPECTION METHOD

(71) Applicant: CANON KABUSHIKI KAISHA, Tokyo (JP)

(72) Inventors: SHINJIRO TOBA, Kanagawa (JP); RYOJI KUSUDO, Kanagawa (JP); RYUJI KOSHITA, Kanagawa (JP); YUUSUKE SAITO, Kanagawa (JP); RYO NISHIMURA, Kanagawa (JP); SHIGEMI KAMOSHIDA, Kanagawa (JP); TSUYOSHI OGAWA, Tokyo (JP); YUUJI OBUKURO, Saitama (JP)

(21) Appl. No.: 19/171,733

(22) Filed: Apr. 7, 2025

(30) Foreign Application Priority Data
Apr. 12, 2024 (JP) 2024-065017

(51) Int. Cl. G03G 21/16; G03G 15/00; G03G 15/08

(52) U.S. Cl. CPC G03G 21/1647; G03G 15/0865; G03G 15/55

(57) ABSTRACT

A container that stores developer and that is arranged in an image forming apparatus is integrally configured by joining a first member and a second member, which are resin members, with an adhesive, and the adhesive is added with a fluorescent agent.

### BACKGROUND OF THE INVENTION

### Field of the Invention

The present invention relates to a container and an inspection method.

### Description of the Related Art

An electrophotographic image forming apparatus (image forming apparatus) is an apparatus that forms an image on a recording medium by using an electrophotographic image forming method. The image forming apparatus is exemplified by an electrophotographic copier, an electrophotographic printer (LED printer, laser beam printer, and the like), a facsimile machine, and a word processor.

Japanese Patent Application Publication No. H6-019241 discloses a cartridge that is detachable from an image forming apparatus and that forms a toner storage section that stores toner by welding together a first frame and a second frame.

### SUMMARY OF THE INVENTION

An object of the present invention is to further develop conventional cartridges.

The present invention provides a container for storing a developer, comprising:
a first member;
a second member; and
a connection member configured to connect the first member and the second member, wherein
fluorescent agent is added to the connection member.

The present invention provides a new type of cartridge.

Further features of the present invention will become apparent from the following description of exemplary embodiments with reference to the attached drawings.

### BRIEF DESCRIPTION OF THE DRAWINGS

FIG. 1 is a schematic cross-sectional view showing the configuration of a printer;

FIG. 2 is a perspective view of a process cartridge and a toner cartridge;

FIG. 3 is a perspective view of a process cartridge and a toner cartridge;

FIG. 4 is a side view of a process cartridge and a toner cartridge;

FIG. 5 is a side view of a process cartridge and a toner cartridge;

FIG. 6 is a cross-sectional view of a process cartridge and a toner cartridge;

FIG. 7 is a diagram of a process cartridge and a toner cartridge as viewed from a removal direction;

FIG. 8 is an explanatory diagram of a memory tag;

FIG. 9 is a perspective view showing the arrangement of a memory tag of a process cartridge;

FIG. 10 is a top view showing the arrangement of a memory tag of a process cartridge;

FIG. 11 is a cross-sectional view showing the arrangement of a memory tag of a process cartridge;

FIG. 12 is a perspective view describing an attachment member;

FIG. 13 is a side view showing the arrangement of the memory tag of the process cartridge;

FIG. 14 is a cross-sectional view showing the attachment of a toner cartridge to a process cartridge;

FIGS. 15A and 15B are perspective views showing the configuration of the attachment member;

FIGS. 16A and 16B are views showing the attachment member and part of a cleaning recovery chamber;

FIGS. 17A and 17B are perspective views showing the configuration of the attachment member;

FIGS. 18A and 18B are cross-sectional views showing the configuration of the attachment member;

FIGS. 19A and 19B are perspective views describing an observation method;

FIGS. 20A to 20C are views describing the observation method;

FIG. 21 is a view showing an example of the observation method;

FIGS. 22A to 22C are views showing an example of the observation method;

FIG. 23 is a cross-sectional view showing the configuration of a cleaning frame;

FIGS. 24A to 24C are views showing the joining process of the cleaning frame; and

FIGS. 25A to 25D are views showing the inspection process of the adhesive application state.

### DESCRIPTION OF THE EMBODIMENTS

Below, a preferred embodiment of the present invention will be described in detail with reference to the drawings. However, the dimensions, materials, shapes, and relative positions of the components described in the following embodiments should be changed as appropriate depending on the configuration and various conditions of the apparatus to which the present invention is applied. Therefore, unless otherwise specified, the scope of the present invention is not intended to be limited thereto.

### Embodiments

### Overview of Printer

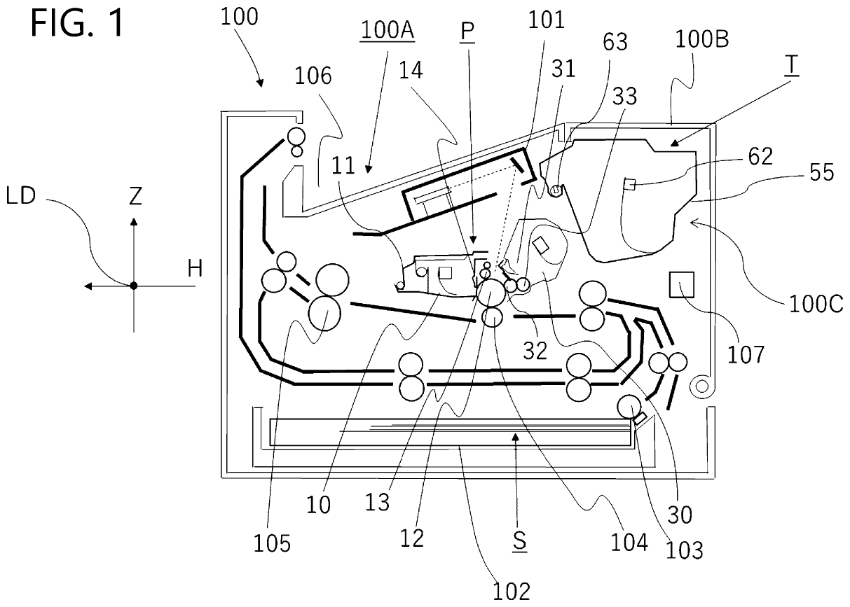

The basic configuration and operation of a printer 100 as an image forming apparatus according to this embodiment will be described with reference to FIG. 1. FIG. 1 is a schematic cross-sectional view showing the configuration of the printer 100 according to this embodiment. Arrow Z indicates the vertical direction, and arrow H indicates the horizontal direction.

As shown in FIG. 1, the printer 100 has an apparatus body 100A, a process cartridge P as a cartridge removably attached to the apparatus body 100A, and a toner cartridge T.

The apparatus body 100A has a scanner 101 as an exposure apparatus, a stacking tray 102 on which sheets S are stacked, a paper feed roller 103, a transfer roller 104, a fixing unit 105, a discharge tray 106, and a control unit 107. The process cartridge P and the toner cartridge (developer cartridge) T are removably attached to the apparatus body 100A.

The process cartridge P has a drum unit 10 having a photosensitive drum 12, a cleaning blade (cleaning member) 14, a charging roller (charging member) 13, and a drum frame 11, and a developing unit 30 having a developing roller 32 and a developing frame 31. The photosensitive drum 12 is rotatably supported by the drum frame 11. The developing roller 32 is rotatably supported by the developing frame 31.

The toner cartridge T can be attached to the process cartridge P. The toner cartridge T stores toner as a developer and is configured to supply the toner to the developing unit 30 of the process cartridge P. The toner cartridge T has a toner conveying member 62, a toner conveying screw 63, and a toner frame 55. The toner conveying member 62 and the toner conveying screw 63 are rotatably supported by the toner frame 55.

The image forming operation on the sheet S will be described. The control unit 107 of the printer 100 starts the image forming operation on the sheet S based on a signal received from an external apparatus.

First, the photosensitive drum 12 is rotated by the drive source of the apparatus body 100A. With a charging voltage applied to the charging roller 13, the charging roller 13 is rotated by the photosensitive drum 12. As a result, the surface of the photosensitive drum 12 is uniformly charged. Based on the image information, the scanner 101 irradiates the charged surface of the photosensitive drum 12 with a laser, forming an electrostatic latent image on the surface of the photosensitive drum 12.

Toner is supplied from the developing roller 32 to the photosensitive drum 12, and the electrostatic latent image is developed into a toner image. As the photosensitive drum 12 rotates, the toner image formed on the photosensitive drum 12 is conveyed toward a transfer section formed between the transfer roller 104 and the photosensitive drum 12.

Meanwhile, a sheet S is fed from the stacking tray 102 by the paper feed roller 103. The sheet S is conveyed to the transfer section in accordance with the timing when the toner image formed on the photosensitive drum 12 reaches the transfer section.

A transfer voltage is applied to the transfer roller 104, and the toner image is transferred from the photosensitive drum 12 to the sheet S. Residual toner that has not been transferred to the sheet S is removed from the surface of the photosensitive drum 12 by the cleaning blade 14.

The sheet S with the toner image transferred thereon is conveyed toward the fixing unit 105. When the sheet S passes through the fixing unit 105, the fixing unit 105 heats and presses the toner image, and the toner image is fixed to the sheet S.

The printer 100 according to this embodiment can perform double-sided printing, in which an image is formed on both the front and back sides of the sheet S. When an image is formed only on the front side of the sheet S, the sheet S that has passed through the fixing unit 105 is discharged to the discharge tray 106. On the other hand, when double-sided printing is performed, the sheet S with the toner image fixed on the front side is conveyed again toward the transfer section through the double-sided conveying path, and a toner image is formed on the back side of the sheet S. Then, the sheet S passes through the fixing unit 105 and is discharged to the discharge tray 106.

### Attachment and Removal of Process Cartridge and Toner Cartridge

The attachment and removal of the process cartridge P and the toner cartridge T according to this embodiment will be described using FIGS. 1, 2, 3, 4, and 5.

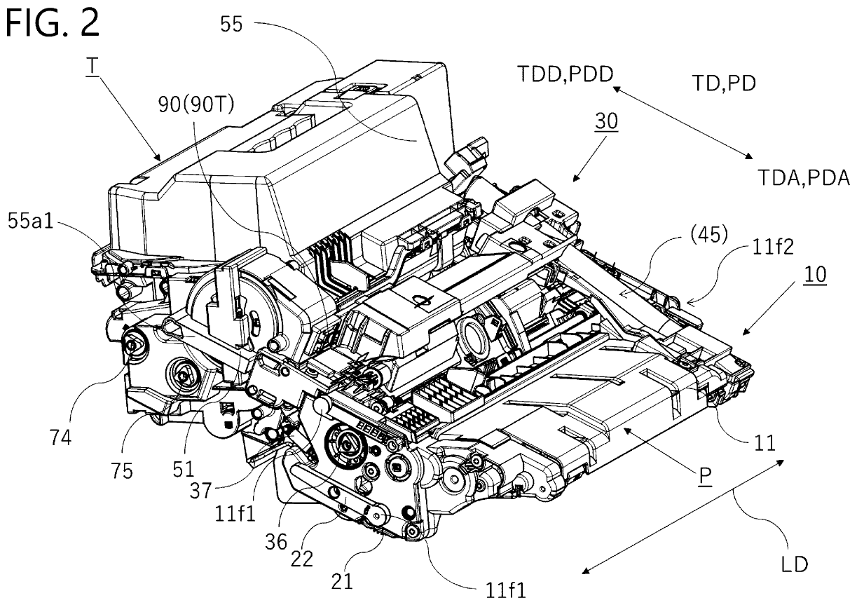

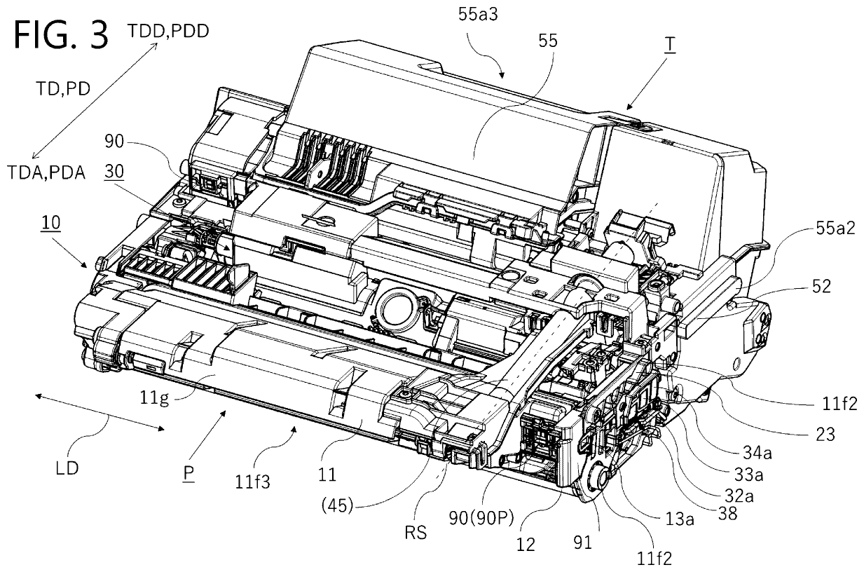

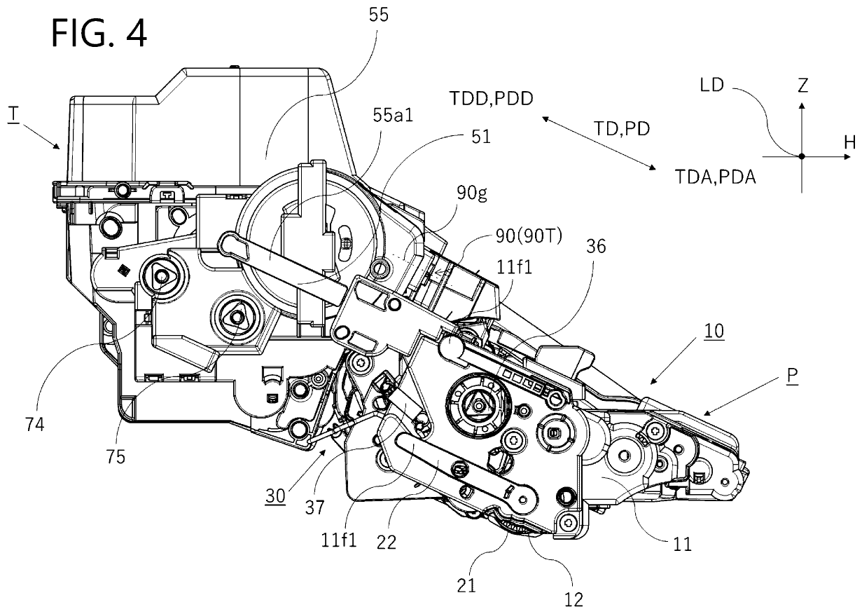

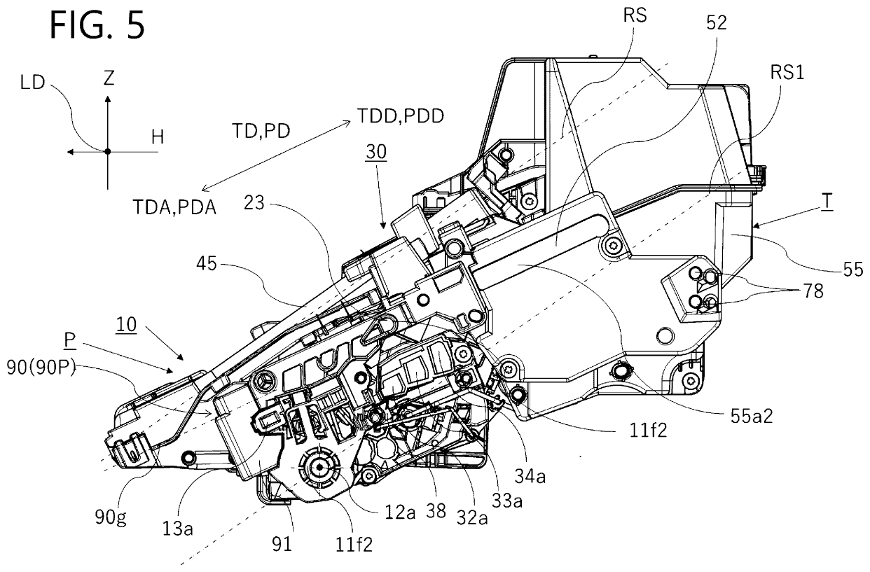

FIGS. 2 and 3 are perspective views of the process cartridge P and the toner cartridge T. FIGS. 4 and 5 are side views of the process cartridge P and the toner cartridge T.

As shown in FIG. 5, the photosensitive drum 12 can rotate around a rotational axis (first axis) 12a. The direction in which the rotational axis 12a extends is called the rotational axis direction (axial direction) of the photosensitive drum 12.

FIG. 2 is a perspective view of the process cartridge P and the toner cartridge T as seen from the driving side. FIG. 3 is a perspective view of the process cartridge P and the toner cartridge T as seen from the non-driving side. FIG. 4 is a side view of the driving side of the process cartridge P and the toner cartridge T as seen in the rotational axis direction of the photosensitive drum 12. FIG. 5 is a side view of the non-driving side of the process cartridge P and the toner cartridge T as seen in the rotational axis direction of the photosensitive drum 12.

As shown in FIG. 1, the printer 100 has a door (opening/closing member) 100B that covers an opening 100C of the apparatus body 100A. The door 100B is rotatably attached to the apparatus body 100A. The door 100B is configured to be movable between a closing position in which it covers the opening 100C and an open position in which the opening 100C is exposed. With the door 100B in the open position, the process cartridge P and toner cartridge T can be attached to the apparatus body 100A and removed from the apparatus body 100A through the opening 100C.

As shown in FIGS. 2 and 3, in the rotational axis direction of the photosensitive drum 12, the drum frame 11 has a process driving end (first end of the drum frame 11) 11f1 and a process non-driving end (second end of the drum frame 11) 11f2 opposite to the process driving end 11f1. The process driving end 11f1 and the process non-driving end 11f2 are the outermost parts (ends) of the drum frame 11 in the rotational axis direction of the photosensitive drum 12. There may be multiple process driving ends 11f1 and multiple process non-driving ends 11f2. The center of the drum frame 11 in the rotational axis direction of the photosensitive drum 12 is called the center 11f3. The distance from the center 11f3 of the drum frame 11 to the process driving end 11f1 is equal to the distance from the center 11f3 to the process non-driving end 11f2.

In this embodiment, the process driving end 11f1 and the process non-driving end 11f2 are the outermost parts (ends) of the process cartridge P in the rotational axis direction of the photosensitive drum 12. In other words, in the rotational axis direction of the photosensitive drum 12, the process driving end 11f1 and the process non-driving end 11f2 coincide with the driving end (first end of the process cartridge P) and the non-driving end (second end of the process cartridge P) of the process cartridge P.

In the rotational axis direction of the photosensitive drum 12, the side on which the process driving end 11f1 is located with respect to the center 11f3 of the drum frame 11 is the driving side of the drum frame 11 or the driving side of the process cartridge P. In the rotational axis direction of the photosensitive drum 12, the side on which the process non-driving end 11f2 is located with respect to the center 11f3 of the drum frame 11 is the non-driving side of the drum frame 11 or the non-driving side of the process cartridge P. In this embodiment, in the rotational axis direction of the photosensitive drum 12, the center 11f3 of the drum frame 11 is the same as the center of the process cartridge P.

In the rotational axis direction of the photosensitive drum 12, the driving side of the drum frame 11 or the driving side of the process cartridge P is located opposite to the non-driving side of the drum frame 11 or the non-driving side of the process cartridge P.

As described below, the toner conveying member 62 is rotatable around the rotational axis 62a. The direction in which the rotational axis 62a extends is called the rotational axis direction (axial direction) of the toner conveying member 62. The toner conveying screw 63 is rotatable around the rotational axis 63a. The direction in which the rotational axis 63a extends is called the rotational axis direction (axial direction) of the toner conveying screw 63.

In the rotational axis direction of the toner conveying screw 63, the toner frame 55 has a toner driving end (first end of the toner frame 55) 55a1 and a toner non-driving end 55a2 (second end of the toner frame 55) opposite to the toner driving end 55a1. The toner driving end 55a1 and the toner non-driving end 55a2 are the outermost parts (ends) of the toner frame 55 in the rotational axis direction of the toner conveying screw 63. There may be multiple toner driving ends 55a1 and multiple toner non-driving ends 55a2. In the rotational axis direction of the toner conveying screw 63, the center of the toner frame 55 is called the center 55a3. The distance from the center 55a3 of the toner frame 55 to the toner driving end 55a1 is equal to the distance from the center 11f3 to the toner non-driving end 55a2.

In this embodiment, the toner driving end 55a1 and the toner non-driving end 55a2 are the outermost parts (ends) of the toner cartridge T in the rotational axis direction of the toner conveying screw 63. In other words, in the rotational axis direction of the toner conveying screw 63, the toner driving end 55a1 and the toner non-driving end 55a2 coincide with the driving end (first end of the toner cartridge T) and the non-driving end (second end of the toner cartridge T) of the toner cartridge T.

In the rotational axis direction of the toner conveying screw 63, the side where the toner driving end 55a1 is located with respect to the center 55a3 of the toner frame 55 is the driving side of the toner frame 55 or the driving side of the toner cartridge T. In the rotational axis direction of the toner conveying screw 63, the side where the toner non-driving end 55a2 is located with respect to the center 55a3 of the toner frame 55 is the non-driving side of the toner frame 55 or the non-driving side of the toner cartridge T. In this embodiment, in the rotational axis direction of the toner conveying screw 63, the center 55a3 of the toner frame 55 is the same as that of the toner cartridge T.

In the rotational axis direction of the toner conveying screw 63, the driving side of the toner frame 55 or the driving side of the toner cartridge T is located opposite to the non-driving side of the toner frame 55 or the non-driving side of the toner cartridge T.

In this embodiment, the rotational axis direction of the photosensitive drum 12, the rotational axis direction of the toner conveying member 62, and the rotational axis direction of the toner conveying screw 63 are parallel to each other. Therefore, the rotational axis direction of the photosensitive drum 12, the rotational axis direction of the toner conveying member 62, and the rotational axis direction of the toner conveying screw 63 are simply referred to as the axial direction (first direction) LD.

In this embodiment, in the axial direction LD, the position of the center 55a3 of the toner frame 55 and the position of the center 11f3 of the drum frame 11 are the same. However, the position of the center 55a3 of the toner frame 55 and the position of the center 11f3 of the drum frame 11 may be different.

As shown in FIGS. 2 and 4, the process cartridge P has a driving-side process guide 22 on the driving side of the drum frame 11. The toner cartridge T has a driving-side toner guide 51 on the driving side of the toner frame 55. As shown in FIGS. 3 and 5, the process cartridge P has a non-driving-side process guide 23 on the non-driving side of the drum frame 11. The toner cartridge T has a non-driving-side toner guide 52 on the non-driving side of the toner frame 55.

The direction in which the process cartridge P is attached to the apparatus body 100A is called the attachment direction PDA. The direction in which the process cartridge P is removed from the apparatus body 100A is called the removal direction PDD. The attachment direction PDA and the removal direction PDD are collectively called the attachment/removal direction PD. The driving-side process guide 22 and the non-driving-side process guide 23 are formed along the attachment/removal direction PD. The driving-side process guide 22 and the non-driving-side process guide 23 are guided by guide portions of the apparatus body 100A of the apparatus, and the process cartridge P moves in the attachment/removal direction PD relative to the apparatus body 100A of the apparatus.

The direction in which the toner cartridge T is attached to the apparatus body 100A is called the attachment direction TDA. The direction in which the toner cartridge T is removed from the apparatus body 100A is called the removal direction TDD. The attachment direction TDA and the removal direction TDD are collectively called the attachment/removal direction TD. The driving-side toner guide 51 and the non-driving-side toner guide 52 are formed along the attachment/removal direction TD. The driving-side toner guide 51 and the non-driving-side toner guide 52 are guided by the guide portion of the apparatus body 100A, and the toner cartridge T moves in the attachment/removal direction TD relative to the apparatus body 100A.

In this embodiment, the attachment/removal direction PD is a direction intersecting the axial direction LD. It is preferable that the angle between the direction perpendicular to the axial direction LD and the attachment/removal direction PD is smaller than the angle between the axial direction LD and the attachment/removal direction PD. It is more preferable that the attachment/removal direction PD is a direction intersecting the axial direction LD.

In this embodiment, the attachment/removal direction TD is a direction intersecting the axial direction LD. The angle between the attachment/removal direction TD and the direction perpendicular to the axial direction LD is preferably smaller than the angle between the axial direction LD and the attachment/removal direction TD. It is more preferable that the attachment/removal direction TD is a direction perpendicular to the axial direction LD.

In this embodiment, the attachment/removal direction PD and the attachment/removal direction TD are parallel, but the attachment/removal direction PD and the attachment/removal direction TD may be different.

In this embodiment, the process cartridge P is attached and removed in a state where the toner cartridge T is not attached to the apparatus body 100A. In other words, the process cartridge P is attached and removed before the toner cartridge T is attached to the apparatus body 100A.

In a state where the toner cartridge T is not attached to the apparatus body 100A, the process cartridge P is attached to the apparatus body 100A through the opening 100C. Furthermore, in a state where the process cartridge P is attached to the apparatus body 100A, the toner cartridge T is attached to the apparatus body 100A and the process cartridge P through the opening 100C.

In a state where the toner cartridge T and the process cartridge P are attached to the apparatus body 100A, the process cartridge P is located downstream of the toner cartridge T in the attachment direction PDA and the attachment direction TDA.

When the toner cartridge T and the process cartridge P are removed from the apparatus body 100A, the toner cartridge T is removed from the apparatus body 100A and the process cartridge P through the opening 100C. Then, the process cartridge P is removed from the apparatus body 100A through the opening 100C.

### Process Cartridge

The configuration of the process cartridge P according to this embodiment will be described in more detail with reference to FIGS. 2, 3, 4, 5, 6, and 7.

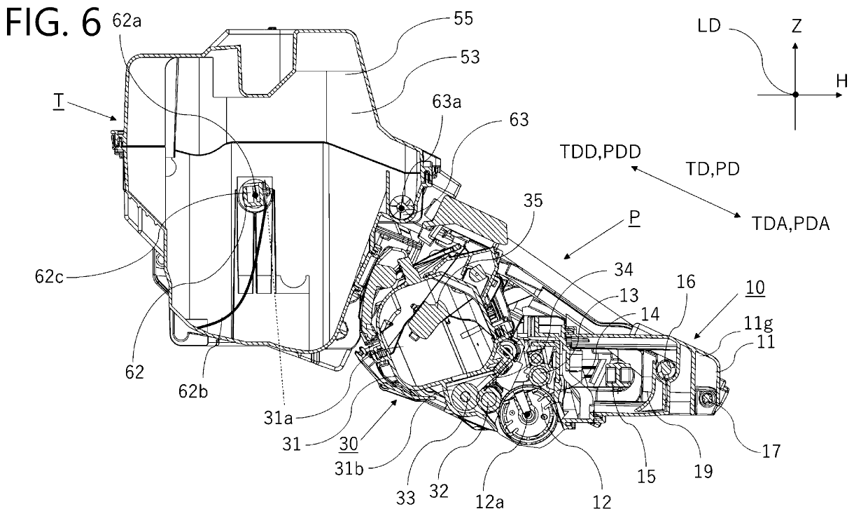

FIG. 6 is a cross-sectional view of the process cartridge P and the toner cartridge T. Specifically, FIG. 6 is a cross-sectional view of the process cartridge P and the toner cartridge T, taken along a cross-sectional direction perpendicular to the axial direction LD.

The process cartridge P includes the developing unit 30 and the drum unit 10. The developing unit 30 is movably (rotatably) connected to the drum unit 10. As shown in FIGS. 4 and FIG. 5, the process cartridge P has a driving-side spring 37 and a non-driving-side spring 38.

The driving-side spring 37 and the non-driving-side spring 38 are attached to the drum unit 10 and the developing unit 30. The driving-side spring 37 and the non-driving-side spring 38 bias the developing unit 30 so that the developing roller 32 is pressed against the photosensitive drum 12.

As shown in FIG. 6, the developing unit 30 has a developing frame 31, a developing roller 32 (developer bearing member) that bears toner, a supply roller 33 (supply member) that contacts the developing roller 32 to supply toner, a developing blade 34, and a stirring member 35. The developing frame 31 supports the developing roller 32, the supply roller 33, the developing blade 34, and the stirring member 35. The developing frame 31 is provided with a developing storage chamber 31a and a developing chamber 31b as a storage section. The stirring member 35 is disposed in the developing storage chamber 31a, and the developing roller 32, the supply roller 33, and the developing blade 34 are disposed in the developing chamber 31b.

The toner supplied from the toner cartridge T is stored in the developing storage chamber 31a. The stirring member 35 conveys the toner stored in the developing storage chamber 31a to the developing chamber 31b. The toner conveyed to the developing chamber 31b is supplied to the developing roller 32 by the supply roller 33 that rotates in contact with the developing roller 32. The toner supplied to the developing roller 32 is regulated by the developing blade 34, and a toner layer is formed on the surface of the developing roller 32. The developing blade 34 functions as a layer thickness regulating member that regulates the thickness of the toner layer.

As shown in FIG. 6, the drum unit 10 has the drum frame 11. The drum frame 11 supports the photosensitive drum 12, the charging roller 13, the cleaning blade 14, the intermediate conveying member 15, the intermediate screw 16, and the transmission shaft 17. The drum unit 10 further has a memory tag 90P, which will be described later. The drum frame 11 has a cleaning recovery chamber 19.

The charging roller 13 is in contact with the photosensitive drum 12 and is rotated by the photosensitive drum 12. The cleaning blade 14 is in contact with the photosensitive drum 12 and collects the toner remaining on the surface of the photosensitive drum 12. The collected toner is stored in the cleaning recovery chamber 19. The drum unit 10 may have a return screw for returning the collected toner to the toner cartridge T.

As shown in FIGS. 2 to 4, the process cartridge P has a process coupling 36 (first input portion, developing drive member) and a drum gear 21 (second input portion, drum drive member). The process coupling 36 engages with the body coupling of the apparatus body 100A, so that a driving force (external force) is transmitted from the apparatus body 100A to the process coupling 36. The drum gear 21 engages with the body gear of the apparatus body 100A, so that a driving force (external force) is transmitted from the apparatus body 100A to the drum gear 21, and the drum gear 21 rotates. As the drum gear 21 rotates, the photosensitive drum 12 is driven and rotates.

As shown in FIGS. 3 and 5, the developing roller electrode 32a, the developing blade electrode 34a, the supply roller electrode 33a, and the charging roller electrode 13a are disposed on the non-driven side of the process cartridge P. The developing roller electrode 32a, the developing blade electrode 34a, the supply roller electrode 33a, and the charging roller electrode 13a are electrically connected to the developing roller 32, the developing blade 34, the supply roller 33, and the charging roller 13, respectively. When an image forming operation is performed, a predetermined voltage is applied to the developing roller electrode 32a, the developing blade electrode 34a, the supply roller electrode 33a, and the charging roller electrode 13a from the power source of the apparatus body 100A.

In this embodiment, the rotational axis directions of the developing roller 32, the supply roller 33, the stirring member 35, the charging roller 13, the intermediate conveying member 15, the intermediate screw 16, and the transmission shaft 17 are parallel to the axial direction LD. The rotational axis direction of each gear except for the process coupling 36 and the drum gear 21 is also parallel to the axial direction LD.

### Toner Cartridge

The configuration of the toner cartridge T according to this embodiment will be described with reference to FIG. 6. As shown in FIG. 6, the toner frame 55 of the toner cartridge T is provided with a toner storage chamber 53. The toner storage chamber 53 stores the toner to be supplied to the process cartridge P. When the toner collected from the photosensitive drum 12 is returned to the toner cartridge T, a recovery chamber for storing the collected toner may be provided separately from the toner storage chamber.

### Configuration of Memory

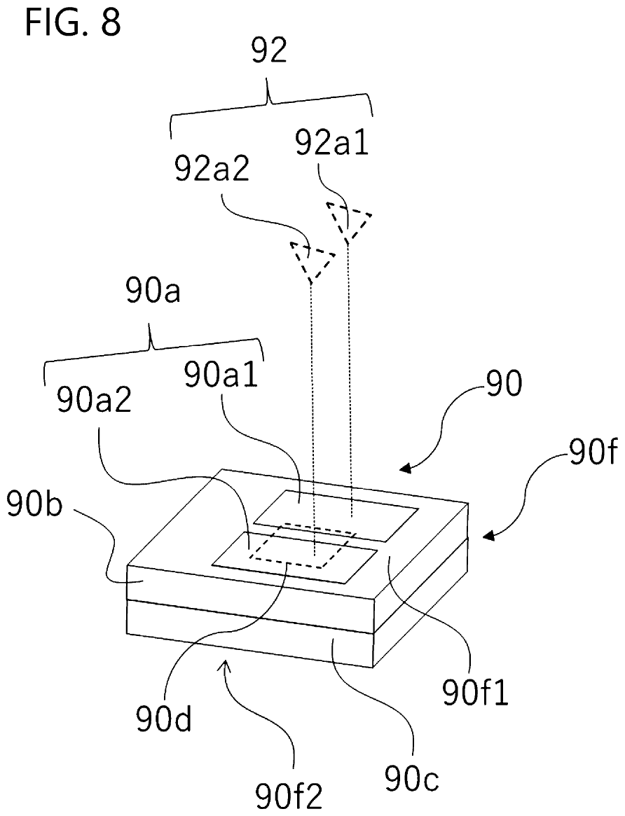

The configuration of a memory will be described with reference to FIG. 8, which is an explanatory diagram of the memory tag 90.

The process cartridge P in this embodiment has a memory tag 90P as a memory for storing information about the process cartridge P. The toner cartridge T also has a memory tag 90T as a memory for storing information about the toner cartridge T. The information stored includes, for example, information about the usage history of the process cartridge P and the toner cartridge T.

The memory tag 90P of the process cartridge P and the memory tag 90T of the toner cartridge T have similar shapes. When the memory tag 90P and the memory tag 90T are not distinguished from each other, or when matters common to the memory tag 90P and the memory tag 90T are described, the memory tag 90P and the memory tag 90T are simply referred to as the memory tag 90.

As shown in FIG. 8, the memory tag 90 in this embodiment has a storage element 90d that stores information about the process cartridge P or the toner cartridge T, and a conductive portion (electrode portion, interface portion, memory contact) 90a electrically connected to the storage element 90d. The conductive portion 90a includes a first electrode (first terminal, first memory electrode, first memory contact) 90a1 and a second electrode (second terminal, second memory electrode, second memory contact) 90a2, and the first electrode 90a1 and the second electrode 90a2 are electrically connected to the storage element 90d.

The memory tag 90 has a holding portion (holding substrate) 90b that holds the conductive portion 90a (first electrode 90a1, second electrode 90a2). The memory tag 90 includes a protective portion 90c that covers and protects the storage element 90d. In this embodiment, the conductive portion 90a is disposed on one surface (front side) of the holding portion 90b, and the storage element 90d is disposed on the other surface (back side) of the holding portion 90b.

The memory tag 90 in this embodiment is a plate-shaped member with an area of 5.5 mm×5 mm and a thickness of 1.4 mm. The holding portion 90b and the protective portion 90c are integrated. The memory tag 90 has a two-layer structure formed by the holding portion 90b and the protective portion 90c. The holding portion 90b and the protective portion 90c form a substrate portion (substrate) 90f that includes the conductive portion 90a.

The substrate 90f has a front surface 90f1 on which the conductive portion 90a is disposed, and a back surface 90f2 on the back side of the front surface 90f1.

The control unit 107 of the printer 100 electrically connects to the storage element 90d via the conductive portion 90a, reads out the information stored in the storage element 90d, and controls the printer 100.

Specifically, the apparatus body 100A is provided with a body contact (body electrode) 92 that contacts the conductive portion 90a in a state where the process cartridge P or the toner cartridge T is attached to the apparatus body 100A. The body contact 92 has a first body electrode 92a1 and a second body electrode 92a2. In a state where the process cartridge P or the toner cartridge T is attached to the apparatus body 100A, the first body electrode 92a1 contacts the first electrode 90a1, and the second body electrode 92a2 contacts the second electrode 90a2.

In this embodiment, the number of electrodes arranged in the conductive portion 90a is two, but the present invention is not limited to this. For example, the conductive portion 90a may have three or more electrodes. Additionally, one electrode may be arranged on the holding portion 90b, and the other electrodes may be arranged on a different portion.

Furthermore, the holding portion 90b and the protective portion 90c may be arranged at positions separated from each other. For example, the substrate having the conductive portion 90a and the substrate having the storage element 90d may be arranged at positions separated from each other.

### Arrangement of Memory Tag of Process Cartridge

The arrangement of the memory tag 90P of the process cartridge P will be described using FIGS. 3, 5, 9, 10, 11, 12, and 13.

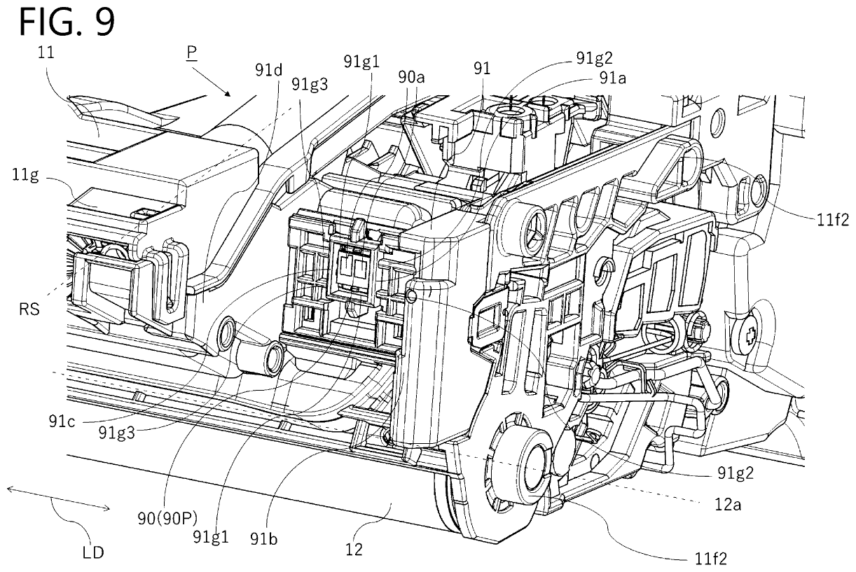

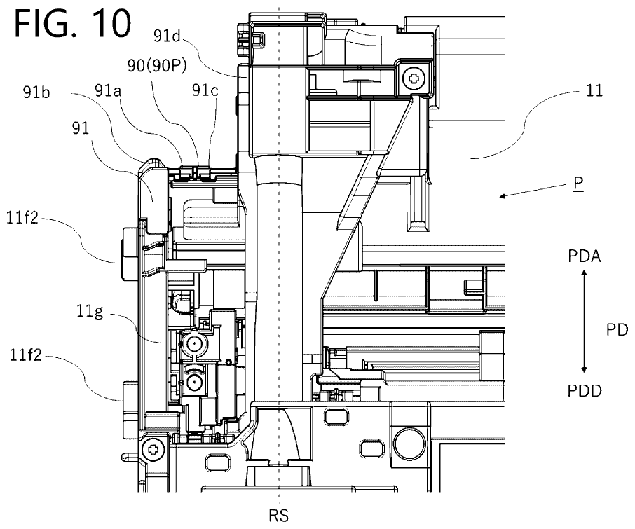

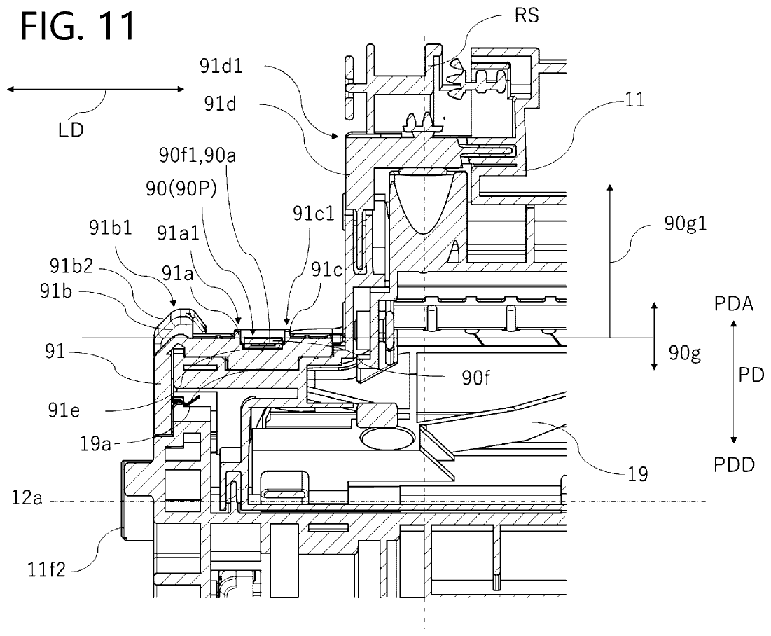

FIG. 9 is a perspective view showing the arrangement of the memory tag 90P of the process cartridge P. FIG. 10 is a top view showing the arrangement of the memory tag 90P of the process cartridge P. FIG. 11 is a cross-sectional view showing the arrangement of the memory tag 90P of the process cartridge P. FIGS. 10 and 11 are views of the memory tag 90P viewed in a direction parallel to the surface 90f1 on which the conductive portion 90a is arranged and perpendicular to the axial direction LD.

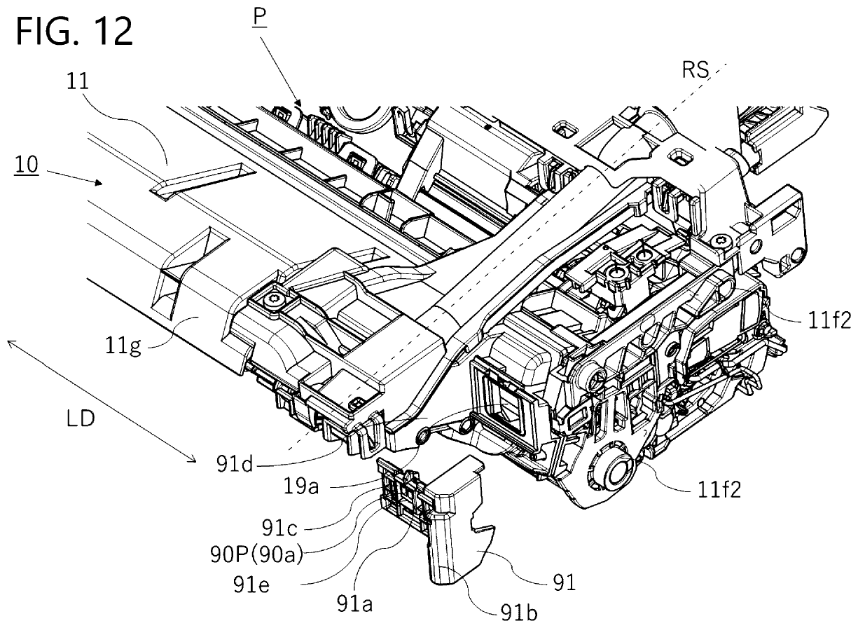

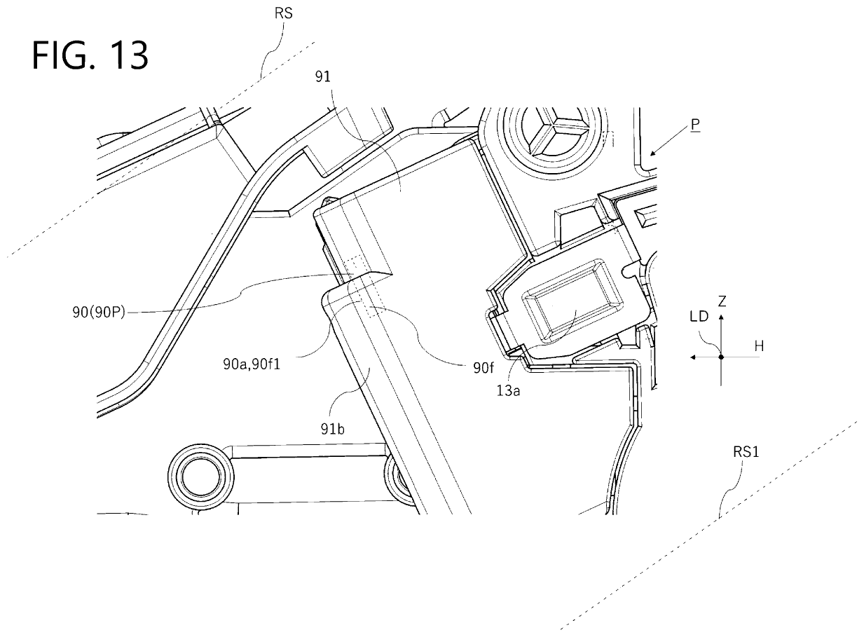

FIG. 12 is a perspective view illustrating the attachment member 91. FIG. 13 is a side view showing the arrangement of the memory tag 90P of the process cartridge P. FIG. 12 is a perspective view showing the state before the memory tag 90P of the process cartridge P and the attachment member 91 for attaching the memory tag 90P are attached. FIG. 13 is a side view showing the attachment member 91 to which the memory tag 90P of the process cartridge P is attached.

The substrate 90f of the memory tag 90P is attached to the drum frame 11. More specifically, the drum frame 11 has a recovery container (container) 11g equipped with a cleaning recovery chamber 19 and an attachment member 91 to which the memory tag 90P is attached. The recovery container 11g is equipped with a cleaning recovery chamber 19 and a cleaning opening 19a communicating with the cleaning recovery chamber 19. The attachment member 91 is attached to the recovery container 11g so as to cover the cleaning opening 19a. In this embodiment, the attachment member 91 is adhered to the recovery container 11g. The substrate 90f of the memory tag 90P is supported by the attachment member 91.

The attachment member 91 of the process cartridge P is disposed on the non-driven side of the process cartridge P. In the axial direction LD, the distance between the attachment member 91 and the process non-driving end 11f2 is shorter than the distance between the attachment member 91 and the process driven end 11f1.

In the axial direction LD, the attachment member 91 is disposed near the process non-driving end 11f2. In the axial direction LD, the distance between the process non-driving end 11f2 and the attachment member 91 is shorter than the distance between the center 11f3 of the drum frame 11 and the attachment member 91.

In the axial direction LD, the entire memory tag 90P is disposed between the process driven end 11f1 and the process non-driving end 11f2. In this embodiment, in the axial direction LD, the entire memory tag 90P is disposed between the non-driving end 11f2 and the center 11f3 of the drum frame 11. In other words, in the axial direction LD, the entire memory tag 90P is disposed on the non-driving side of the drum frame 11 (the non-driving side of the process cartridge P).

In the axial direction LD, the distance between the conductive portion 90a of the memory tag 90P and the process non-driving end 11f2 is shorter than the distance between the conductive portion 90a of the memory tag 90P and the process driven end 11f1. In addition, in the axial direction LD, the distance between the memory tag 90P and the process non-driving end 11f2 is shorter than the distance between the memory tag 90P and the process driven end 11f1.

In the axial direction LD, the distance between the process non-driving end 11f2 and the conductive portion 90a of the memory tag 90P is shorter than the distance between the center 11f3 of the drum frame 11 and the conductive portion 90a of the memory tag 90P. In addition, in the axial direction LD, the distance between the process non-driving end 11f2 and the memory tag 90P is shorter than the distance between the center 11f3 of the drum frame 11 and the memory tag 90P.

As shown in FIGS. 10 and 11, the drum frame 11 has a first protruding portion 91a, a second protruding portion 91b, a third protruding portion 91c, and a fourth protruding portion 91d. At least part of the fourth protruding portion 91d functions as a wall that forms the cleaning recovery chamber 19.

In this embodiment, the first protruding portion 91a, the second protruding portion 91b, the third protruding portion 91c, and the fourth protruding portion 91d are arranged on the non-driving side of the drum frame 11. In the axial direction LD, the distance between the process non-driving end 11f2 and the first protruding portion 91a and the second protruding portion 91b is shorter than the distance between the process driving end 11f1 and the first protruding portion 91a and the second protruding portion 91b. In the axial direction LD, the distance between the non-driving end 11f2 and the third protruding portion 91c and the fourth protruding portion 91d is shorter than the distance between the driving end 11f1 and the third protruding portion 91c and the fourth protruding portion 91d.

Furthermore, in the axial direction LD, the distance between the non-driving end 11f2 and the first protruding portion 91a and the second protruding portion 91b is shorter than the distance between the center 11f3 of the drum frame 11 and the first protruding portion 91a and the second protruding portion 91b. Furthermore, in the axial direction LD, the distance between the non-driving end 11f2 and the third protruding portion 91c and the fourth protruding portion 91d is shorter than the distance between the center 11f3 of the drum frame 11 and the third protruding portion 91c and the fourth protruding portion 91d.

In addition, in the axial direction LD, the distance between the non-driving end 11f2 and the first protruding portion 91a and the second protruding portion 91b is shorter than the distance between the non-driving end 11f2 and the substrate 90f and the conductive portion 90a. In the axial direction LD, the distance between the non-driving end 11f2 and the third protruding portion 91c and the fourth protruding portion 91d is longer than the distance between the non-driving end 11f2 and the substrate 90f and the conductive portion 90a.

In the axial direction LD, the first protruding portion 91a and the third protruding portion 91c are adjacent to the substrate 90f and face the side surface of the holding portion 90b that is perpendicular to the surface 90f1 on which the conductive portion 90a is disposed. In the axial direction LD, the conductive portion 90a of the memory tag 90P is disposed between the first protruding portion 91a and the third protruding portion 11c. In this embodiment, at least one of the first protruding portion 91a and the third protruding portion 11c is in contact with the substrate 90f of the memory tag 90.

Furthermore, in the axial direction LD, the distance between the second protruding portion 91b and the process non-driving end 11f2 is shorter than the distance between the first protruding portion 91a and the process non-driving end 11f2. In the axial direction LD, the first protruding portion 91a is disposed between the second protruding portion 91b and the memory tag 90P, and the second protruding portion 91b is disposed between the first protruding portion 91a and the process non-driving end 11f2.

Furthermore, in the axial direction LD, the distance between the fourth protruding portion 91d and the process non-driving end 11f2 is longer than the distance between the third protruding portion 91c and the process non-driving end 11f2. The distance between the fourth protruding portion 91d and the process driven end 11f1 is shorter than the distance between the third protruding portion 91c and the process driven end 11f1. That is, in the axial direction LD, the third protruding portion is disposed between the substrate 90f and the process driving end 11f1, and the fourth protruding portion 91d is disposed between the third protruding portion 91c and the process driving end 11f1.

Here, the exposure direction 90g1 is defined as the direction parallel to the normal direction 90g of the surface 90f1 of the holding portion 90b of the memory tag 90p, along which the conductive portion 90a is exposed. In other words, the exposure direction 90g1 can be said to be the direction in which the conductive portion 90a faces. In this embodiment, the exposure direction 90g1 is parallel to the attachment direction PDA.

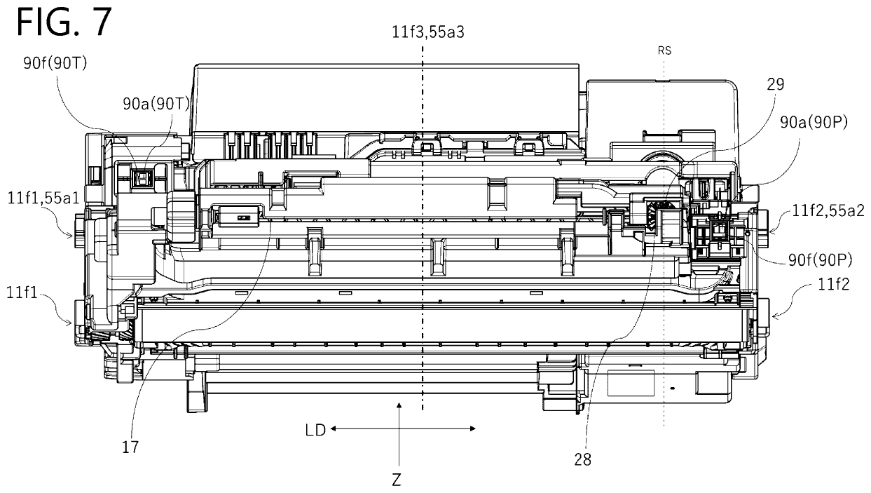

As shown in FIG. 7, when viewed in the direction opposite to the exposure direction 11g1, the entire surface 90f1 of the substrate 90f of the memory tag 90P is exposed. In this embodiment, the substrate 90f is adhered to the attachment member 91 of the drum frame 11, and the movement of the substrate 90f in the exposure direction 90g1 is restricted.

In the exposure direction 90g1, the first protruding portion 91a and the third protruding portion 91c protrude from the surface 90f1 and the conductive portion 90a of the memory tag 90p, the second protruding portion 91b protrudes from the first protruding portion 91a, and the fourth protruding portion 91d protrudes from the third protruding portion 91c.

In other words, in the exposure direction 90g1, the tip 91a1 of the first protruding portion 91a and the tip 91c1 of the third protruding portion 91c are located downstream of the surface 90f1 and the conductive portion 90a. In addition, the tip 91b1 of the second protruding portion 91b and the tip 91d1 of the fourth protruding portion 91d are located downstream of the tip 91a1 of the first protruding portion 91a and the tip 91c1 of the third protruding portion 91c. Furthermore, in the exposure direction 90g1, the tip 91d1 of the fourth protruding portion 91d is located downstream of the tip 91b1 of the second protruding portion 91b.

In the normal direction 90g of the memory tag 90P, the distance between the tip 91b1 of the second protruding portion 91b and the tip 91a1 of the first protruding portion 91a is longer than the distance between the conductive portion 90a and the tip 91a1 of the first protruding portion 91a. The distance between the tip 91d1 of the fourth protruding portion 91d and the tip 91c1 of the third protruding portion 91c is longer than the distance between the conductive portion 90a and the tip 91c1 of the third protruding portion 91c.

In the rotational axis direction 12a of the photosensitive drum 12, the distance between the tip 91b1 of the second protruding portion 91b and the tip 91a1 of the first protruding portion 91a is longer than the distance between the conductive portion 90a and the tip 91a1 of the first protruding portion 91a. The distance between the tip 91d1 of the fourth protruding portion 91d and the tip 91c1 of the third protruding portion 91c is longer than the distance between the conductive portion 90a and the tip 91c1 of the third protruding portion 91c.

In other words, in the exposure direction 90g1, the length by which the second protruding portion 91b protrudes from the first protruding portion 91a is longer than the length by which the first protruding portion 91a protrudes from the surface 90f1. In the exposure direction 90g1, the length by which the fourth protruding portion 91d protrudes from the third protruding portion 91c is longer than the length by which the third protruding portion 91c protrudes from the surface 90f1.

The end of the second protruding portion 91b in the exposure direction 90g1 is provided with an inclined surface 91b2 inclined with respect to the axial direction LD and the exposure direction 90g1.

In addition, in the axial direction LD, the distance between the first protruding portion 91a and the second protruding portion 91b is longer than the distance between the substrate 90f of the memory tag 90P and the first protruding portion 91a. The distance between the third protruding portion 91c and the fourth protruding portion 91d is longer than the distance between the substrate 90f of the memory tag 90P and the third protruding portion 91c.

In addition, as shown in FIG. 13, when viewed in the axial direction LD, at least part of the substrate 90f of the memory tag 90P overlaps with the second protruding portion 91b.

The drum frame 11 has a reinforcing rib connected to at least one of the first protruding portion 91a and the third protruding portion 91c. Specifically, as shown in FIG. 9, a connecting portion 91g1 is connected to the first protruding portion 91a and the third protruding portion 91c in the axial direction LD. A connecting portion 91g2 is connected to the first protruding portion 91a and the second protruding portion 91b in the axial direction LD. A connecting portion 91g3 is connected to the third protruding portion 91c and the fourth protruding portion 91d in the axial direction LD.

The connecting portions 91g1, 91g2, and 91g3 are ribs (reinforcing ribs) that protrude toward the exposure direction 90g1 and extend in the axial direction LD. Each of the connecting portions 91g1 and 91g2 has a function of reinforcing the first protruding portion 91a. Each of the connecting portion 91g1 and the connecting portion 91g3 has a function of reinforcing the third protruding portion 91c. In this embodiment, the connecting portion 91g1, the connecting portion 91g2, and the connecting portion 91g3 are provided on the attachment member 91.

It is preferable that the number of the connecting portion 91g1, the connecting portion 91g2, and the connecting portion 91g3 is plural, but at least one of the connecting portion 91g1, the connecting portion 91g2, and the connecting portion 91g3 may be singular. In this embodiment, the two connecting portions 91g1 are connected via the first protruding portion 91a and the third protruding portion 91c. The two connecting portions 91g2 are also connected via a connecting portion (reinforcing rib), and the two connecting portions 91g3 are also connected via a connecting portion (reinforcing rib).

The memory tag 90P can be protected by the first protruding portion 91a, the second protruding portion 91b, the third protruding portion 91c, and the fourth protruding portion 91d.

Furthermore, the second protruding portion 91b and the fourth protruding portion 91d can also be said to have the function of protecting the first protruding portion 91a and the third protruding portion 91c adjacent to the memory tag 90P. This prevents the first protruding portion 91a and the third protruding portion 91c arranged near the substrate 90f of the memory tag 90P from being deformed by an external force.

Furthermore, in a state where the process cartridge P is attached to the apparatus body 100A, the memory tag 90P is inclined with respect to the horizontal and vertical directions so that the conductive portion 90a faces downward in the vertical direction Z.

As shown in FIG. 12, the attachment member 91 has a first protruding portion 91a, a second protruding portion 91b, and a third protruding portion 91c. The recovery container 11g has a fourth protruding portion 91d. Between the first protruding portion 91a and the third protruding portion 91c, a memory attachment portion 91e to which the memory tag 90P is attached is formed. That is, the memory tag 90P is supported by the attachment member 91 of the drum frame 11 at the memory attachment portion 91e. The memory attachment portion (support portion) 91e supports the substrate 90f of the memory tag 90P.

When a used process cartridge P is collected and reused, toner may be removed from the cleaning recovery chamber 19. According to the configuration shown in this embodiment, when the attachment member 91 is removed from the recovery container 11g, the cleaning opening 19a is exposed, and the toner can be removed from the cleaning recovery chamber 19.

Even if at least one of the first protruding portion 91a, the second protruding portion 91b, and the third protruding portion 91c is deformed, the drum frame 11 can be returned to a state in which the first protruding portion 91a, the second protruding portion 91b, and the third protruding portion 91c are not deformed by replacing the attachment member 91.

Additionally, by removing the attachment member 91 from the recovery container 11g, the memory tag 90P can be removed from the process cartridge P. When the process cartridge P is reused, the memory tag 90P attached to the used process cartridge P may be reused by rewriting the information, or may be replaced with another memory tag 90P.

After removing the attachment member 91 from the recovery container 11g, the attachment member 91 is attached to the recovery container 11g again to close the cleaning opening 19a. At this time, the removed attachment member 91 may be used again, or a different attachment member 91 may be used.

In summary, the removed memory tag 90P and attachment member 91 may be reused. Additionally, at least one of the memory tag 90P and attachment member 91 may be replaced with a new part.

### Detailed Description of Attachment Member 91

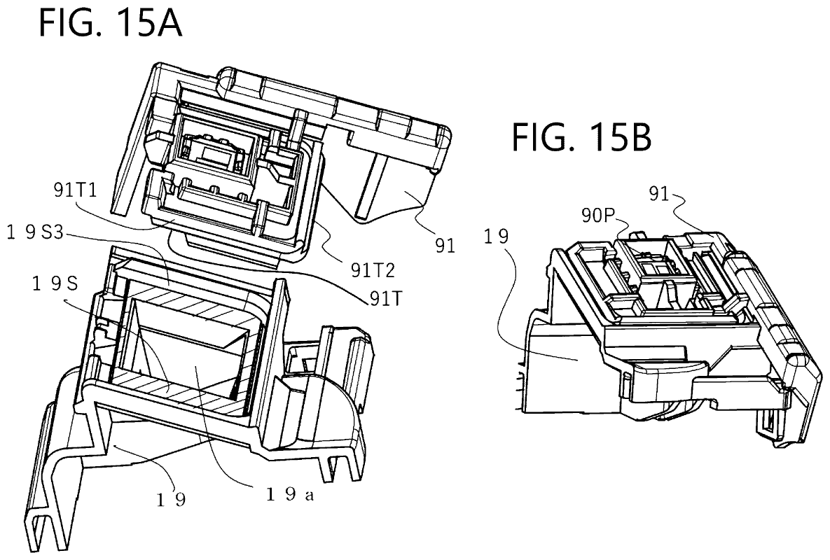

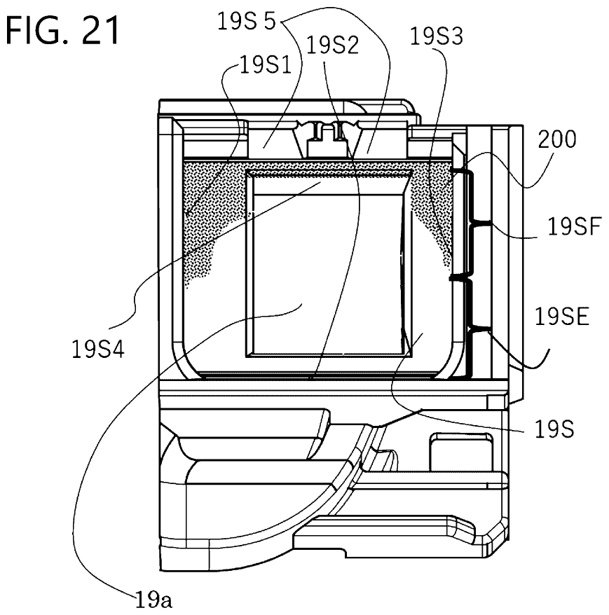

FIGS. 15A and 15B shows the attachment member 91 molded entirely from a transparent material. In reality, the material of the attachment member 91 is not necessarily transparent, but in this figure, it is shown as transparent for reference in describing the state of the adhesive. An adhesive is interposed as a connection member between the joining surface 91S, which is the butting surface on the attachment member side, and the joining surface 19S, which is the butting surface on the cleaning recovery chamber side. In the figure, the location where this adhesive is placed is shown from the normal direction of the joining surface 19S (the front direction of the paper in FIG. 21).

In another configuration, the joining section of the attachment member 91 can be made of a transparent material (not shown) and the other parts can be made of flame-retardant non-transparent material by two-color molding or insert molding to provide a partially transparent area, allowing the adhesive application state to be observed in a similar manner. However, when the entire attachment member 91 is made of a transparent material, for example, if flame retardancy is required for the attachment member 91, a flame retardant must be added. This reduces transparency and the appearance is impaired, such as losing the sense of uniformity in color. In addition, when two-color molding or insert molding is used to make the part transparent, the cost tends to be higher than that of single-color molding. Therefore, it is preferable to use a transparent material in order to observe the adhesive (detect the adhesion state) in more detail, but the material may be appropriately determined based on the balance between cost and aesthetics.

### First Embodiment

Next, the details of the attachment member 91 according to the first embodiment of the present invention will be described with reference to FIGS. 15A and 15B to FIG. 21.

FIG. 15A shows the state before the attachment member 91 is attached, and is a schematic diagram showing a partial cutaway view near the cleaning opening 19a of the cleaning recovery chamber 19 that stores waste developer. The attachment member 91 (first member) made of a resin material and the cleaning recovery chamber 19 (second member) that stores waste developer are made of separate members as described above.

The attachment member 91 is inserted until it abuts against the joining surface 19S shown by hatching, and then temporarily joined together as shown in FIG. 15B, and finally fixed with adhesive 200 (see also FIG. 30).

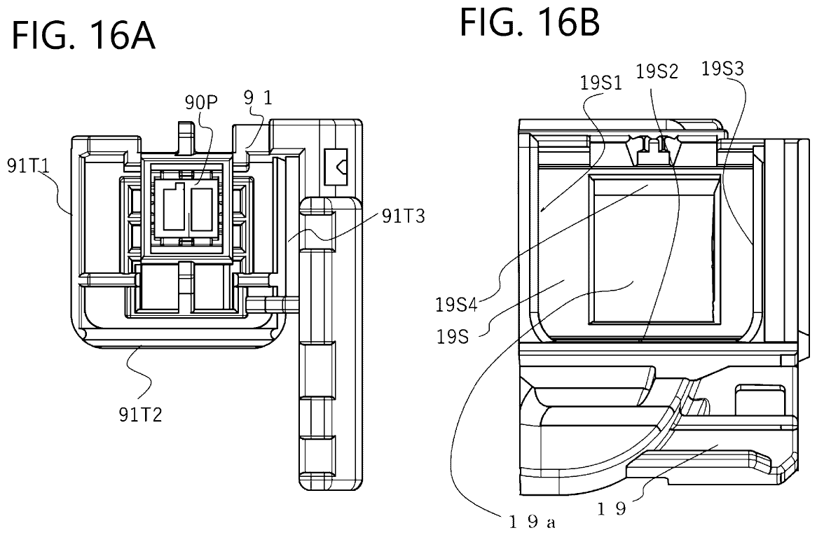

The attachment member 91 will be described in more detail with reference to FIGS. 16A to 18B. The attachment member 91 has joining surfaces 91T1 to 91T4, and the cleaning recovery chamber 19 has joining surfaces 19s1 to 19s4. The joining surfaces 91T1 to 91T4 on the attachment member side and the joining surfaces 19s1 to 19s4 on the cleaning recovery chamber side face each other after positioning. In other words, when determining the position of the attachment member 91 relative to the cleaning recovery chamber 19, the joining surfaces 91T1 to 91T4 are abutted against the joining surfaces 19s1 to 19s4, respectively, and the joining surface 91T is abutted against the joining surface 19S.

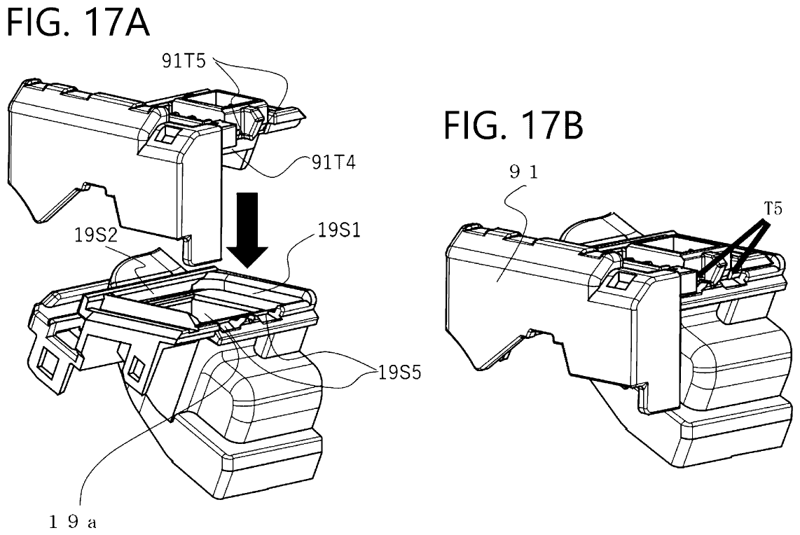

Next, a method for joining these surfaces will be described with reference to FIGS. 17A and 17B. FIGS. 17A and 17B are views of FIGS. 15A and 15B viewed from an injection port T5.

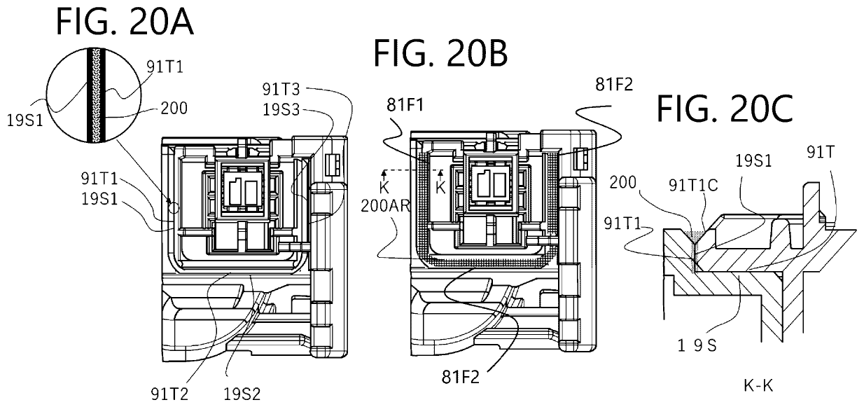

First, as shown in FIG. 17A, the attachment member 91 and the cleaning recovery chamber 19 are fitted together. After that, as shown in FIG. 17B, the adhesive 200 is injected from the injection port T5 formed by the surfaces 91T5 and 19S5. Then, the adhesive is dripped from the injection port T5, and permeates and spreads to each of the joining surfaces (19S1 to S4, 91T1 to T4) shown in FIGS. 20A to 20C by capillary action. As shown in FIG. 20A, in this embodiment, at least part of the joining surfaces 19S4 and 91T4 is not exposed to the outside.

FIG. 21 is a reference diagram for describing the permeation of the adhesive, shown as if passing through the attachment member 91. The adhesive 200 spreads in the order shown here, moving downward from the injection port.

In this embodiment, the attachment member 91 and the cleaning recovery chamber 19 are made of a styrene-based resin material. Additionally, a black-based color is selected. Additionally, D-limonene is used in the adhesive 200, but the container material and adhesive are not limited to this, and other materials may be selected as appropriate. In this embodiment, the adhesive 200 is a limonene adhesive “Tinopal OB CO” manufactured by BASF.

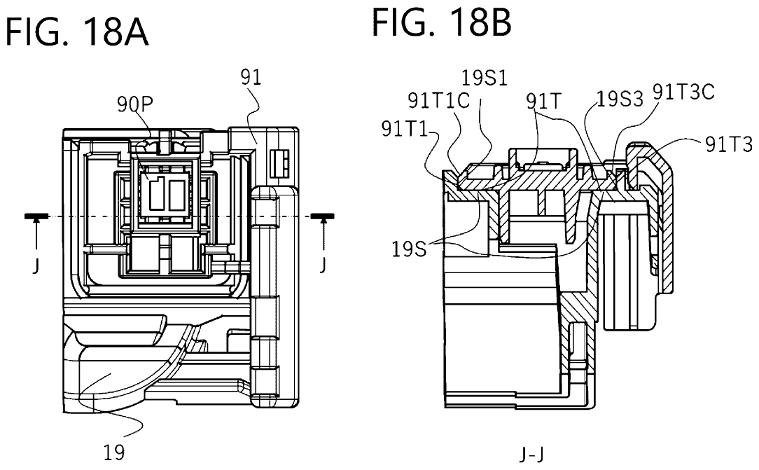

Next, the configuration of the joining surface will be described in more detail with reference to FIGS. 18A and 18B. As described above, the attachment member 91 and the cleaning recovery chamber 19 butt against each other at the joining surface 19S and the joining surface 91T. In addition, the shaft portion (protrusion) formed by the joining surface 91T1 and the joining surface 91T3, which are wall-shaped vertical walls forming an angle with the joining surface 91T, and the hole portion (recess) formed by the joining surface 19S1 and the joining surface 19S3 are fitted together with a small gap therebetween. Furthermore, the shaft portion (protrusion) formed by the joining surface 91T2 and the joining surface 91T4 shown in FIGS. 16A and 16B are also fitted with the hole portion (recess) formed by the joining surface 19S2 and the joining surface 19S4.

With this configuration, the adhesive injected from the above-mentioned injection port permeates into the joining surfaces 19S, 19S1 to 19S4 on the cleaning recovery chamber side and the joining surfaces 91T, 91T1 to 91T4 on the attachment member side by capillary action (FIG. 18B). In this way, the attachment member 91 and the cleaning recovery chamber 19 are joined together.

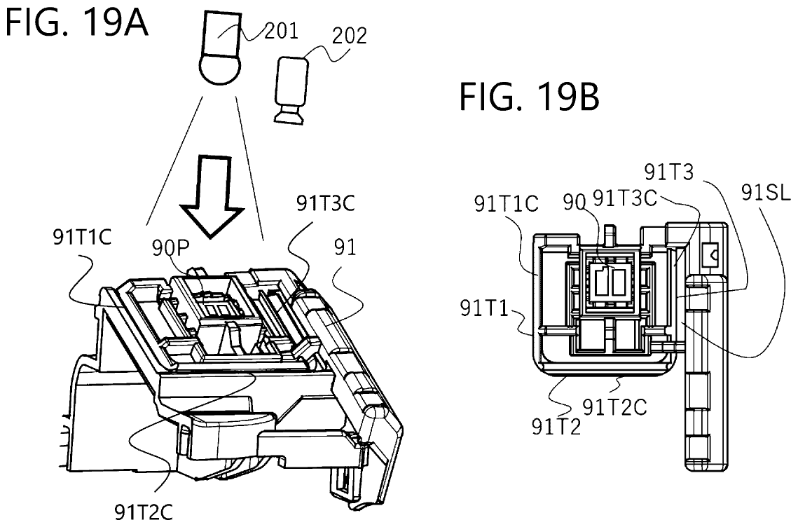

The adhesive 200 used in this embodiment contains a fluorescent agent. The fluorescent agent has the property of emitting strong light when irradiated with black light even in a very small amount. Therefore, by irradiating light with a wavelength that reacts the fluorescent agent, the adhesive 200 that has flowed out (overflowed) into a small gap exposed to the outside can be detected (FIG. 19B).

As a specific detection method, as shown in FIG. 19A, a black light 201 (or a UV light) is irradiated from the direction of the arrow, and an image is captured by a camera 202. Then, the control unit 107 processes the captured image, so that the adhesion state can be detected.

Note that, as shown in FIG. 19B, the attachment member 91 of this embodiment is provided with slits 91SL on the joining surfaces 91T3 and 19S3 so that the application area can be observed over a wide range as continuously as possible. Additionally, chamfered shapes 91T1C, 91T2C, and 91T3C are provided on the ridges of the joining surfaces T1 to T3 so as not to interfere with the irradiated light. By providing these slits and chamfered shapes, the exposed portion of the end of the joining surface to the outside can be increased, and the irradiated light can spread widely. The chamfered shapes 91T1C, 91T2C, and 91T3C are connected to the mating portions 81F1, 81F2, and 81F3, which are the portions exposed on the surface of the container when the attachment member 91 (first member) and the cleaning recovery chamber 19 (second member) are mated. Therefore, the adhesive 244 that has flowed out first leaks out from the mating portions 81F1, 81F2, and 81F3 and spreads to the chamfered shapes 91T1C, 91T2C, and 91T3C. Therefore, the inspection is performed by irradiating an area including at least the mating portions 81F1, 81F2, and 81F3 with light from a black light.

With the above-mentioned configuration, at least part of the adhesive 200 containing a fluorescent agent flows out (overflows) to the approximately parallel ends of the joining surface 19S1 and the joining surface 91T1 (FIGS. 20A and 20C). The adhesive 200 that has permeated to the ends of the three sides of the joining surfaces (91T1, 91S1, 91T2, 91S2, 91T3, 91S3) that become the vertical wall surfaces shown in FIGS. 20A to 20C will emit light when irradiated with black light due to the fluorescent agent contained therein, allowing the application state to be observed. Specifically, the detection area 200AR is observed visually or by image processing of an image captured by a camera.

### Second Embodiment

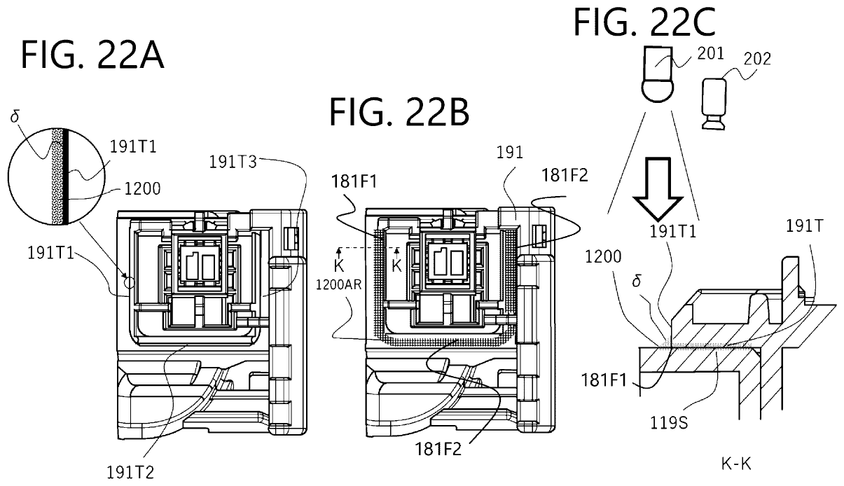

As another example, FIGS. 22A to 22C show an example of a case in which there are no joining surfaces (19S1, 19S2, and 19S3) that become the vertical wall portions shown in FIGS. 20A to 20C.

In this embodiment, as shown in FIG. 22C, there are no vertical wall surfaces facing the vertical wall surfaces 191T1, 191T2, and 191T3 (which are called vertical wall surfaces in this case because they are not joined). Therefore, the joining section is the mating portion between the vertical wall surface 191T1 and the joining surface 119S. That is, the first flat surface 191T of the first member and the joining surface 119S are joined to each other, and the surface of the vertical wall surface 191T1 intersects the joining surface 119S.

Similar to the first embodiment, the adhesive 1200 injected from the injection port permeates into the mating portions 181F1, 181F2, and 181F3 between the vertical wall surface 191T1, which is the abutting surface, and the joining surface 119S by capillary action. Then, the adhesive 1200 reaches the base of the vertical wall surfaces 191T1, 191T2, and 191T3 (which are not joining surfaces in this case) of the attachment member 191, and finally reaches the corner & consisting of the joining surface 119S and the vertical wall surface 191T1 in FIG. 22C. At least the mating portions 181F1, 181F2, and 181F3 are included in the area irradiated with light from the black light, so that the adhesive 1200 leaking out from the joining surface can be observed.

The adhesive 1200 in this embodiment flows out from the gap between the mating portions between the two flat surfaces, the vertical wall surface 191T1 and the joining surface 119S. Here, the adhesive 1200 flowing into the corner 8 flows out (overflows) only from a small area where capillary action occurs. However, even with a small amount of adhesive, the application state can be inspected by observing the light emission in the area 1200AR due to the effect of containing a fluorescent agent.

As described above, as in this embodiment, when joining members molded in a single color, a fluorescent agent-containing adhesive is used for joining, and a black light is irradiated from a direction parallel to the joining surface to cause a small area to emit light, thereby detecting the application state of the adhesive, eliminating the need to use a transparent member as in the past. As a result, it is possible to use a non-transparent, flame-retardant, single-color material, which can lead to lower costs. Furthermore, the range of color options expands, allowing for a more uniform appearance.

The fluorescent agent is added to the adhesive at a ratio of about 0.01 to 6.0 (wt %). The fluorescent agent in this embodiment emits strong fluorescence at a wavelength of about 450 nm. Therefore, it is recommended to use a light with a wavelength close to this (for example, a black light or the like). The type and amount of the additive are not limited to the above-mentioned range of the amount added, and may be appropriately determined depending on the material, detection performance, and other conditions.

In each embodiment of this embodiment, the attachment member 91 that holds the memory tag 90P and the cleaning recovery chamber 19 are joined together. However, the configuration to which the present invention is applied is not limited to this, and the present invention can be preferably applied to a location where a container that stores developer or waste developer is composed of multiple members. In other words, according to this embodiment, when there is a possibility of developer leakage and there is a high need to detect the condition of the adhesive, it is possible to confirm that the joining section of the container composed of multiple members is securely joined.

### Third Embodiment

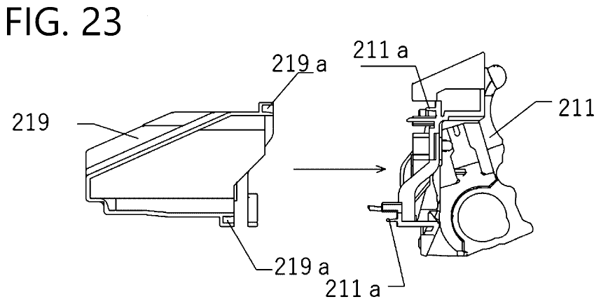

Next, as a third embodiment, a case in which the present invention is applied to a cleaning frame that is a waste developer storage container will be described. As shown in FIG. 23, the cleaning recovery chamber 219 (first member) and the cleaning container 211 (second member) constituting the cleaning frame may be joined using an adhesive. Since the cleaning frame stores toner, the adhesion must be performed with high precision to prevent toner leakage, and it is highly necessary to check the adhesion state.

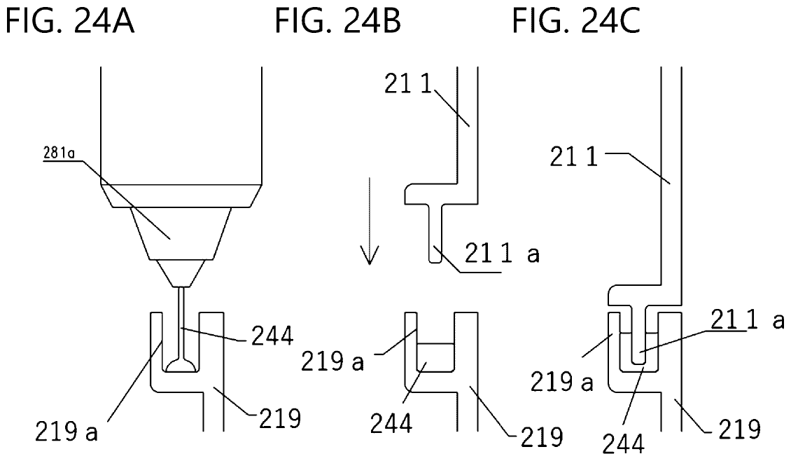

As shown in FIGS. 24A to 24C, the cleaning recovery chamber 219 has a groove 219a, and the cleaning container has a rib-shaped protrusion 211a. The groove 219a and the protrusion 211a are annular and are formed to face each other.

As shown in FIG. 24A, an adhesive 244 as a connection member is applied to the groove 219a formed in the cleaning recovery chamber 219. In this embodiment, hot melt that is applied in a heated state is used as the adhesive 244. The hot melt is injected in a molten state from an application nozzle 281a and applied to the groove 219a (see FIGS. 24A to 24C).

Then, as shown in FIG. 24B, the protrusion 211a is inserted into the groove 219a in the direction of the arrow. Finally, as shown in FIG. 24C, the cleaning recovery chamber 219 and the cleaning container 211 are integrally joined via the adhesive 244.

In this embodiment, the adhesive 244 is colorless and transparent in the molten state when applied, and is applied to the groove 219a, so that it is difficult to check the minute application state visually or by normal image processing. Here, the minute application state means, for example, a minute break in the hot melt and a minute overflow into an unnecessary area.

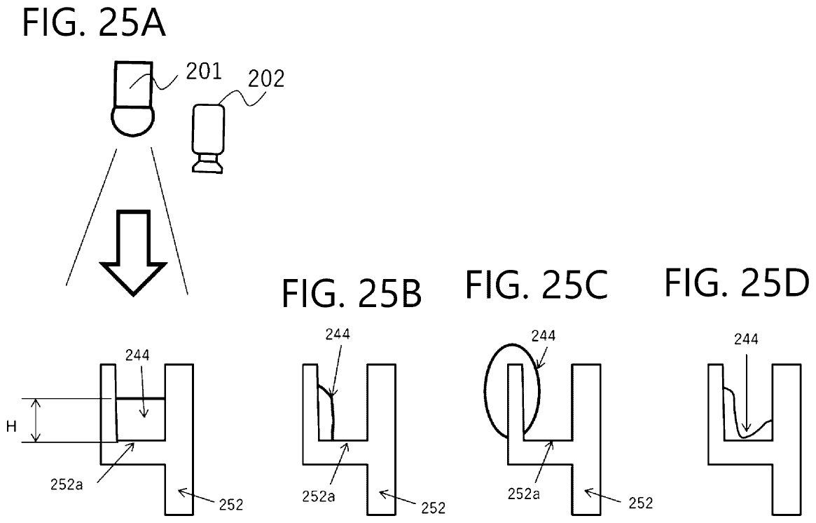

Therefore, as in the first and second embodiments, the adhesive 244 contains a fluorescent agent. Due to this, as shown in FIG. 25A, the minute application state of the adhesive can be detected. FIG. 25A shows a method for detecting the application state. The adhesive 244 emits light by irradiating the adhesive part with a black light 201. The image captured by the camera 202 is subjected to image processing.

According to this embodiment, it is possible to observe the minute application state of the adhesive 244 in a transparent state, which was difficult to do in the past, and it is possible to prevent the outflow of application defects that become a route for toner leakage.

A specific example of application defects will be described with reference to FIGS. 25B and 25C. FIG. 25B shows a state in which the amount of application is insufficient (a state in which the groove 219a is not filled). FIG. 25C shows a state in which the application position is shifted and flows over from the groove 219a. The control unit 107 may, for example, store image information of a state in which the adhesive 244 is normally applied, and detect application defects by performing image processing on the captured image.

Furthermore, other effects can be obtained by this embodiment, which will be described below. Here, if the manufacturing equipment is stopped for a long time due to a sudden abnormality in the manufacturing line, for example, the hot melt may remain at high temperature for a long time. In this case, the hot melt may deteriorate thermally (for example, viscosity reduction, generation of foreign matter such as carbonized matter, and the like), and the stability of the application state may be impaired.

When the viscosity of the hot melt decreases, the adhesive tends to flow downward when applied to an inclined surface. In that case, even if the injection pressure during application is the same, the injection amount increases, and the amount of application increases, increasing the risk that the adhesive 244 will overflow outside the joining section when the cleaning recovery chamber 219 and the cleaning container 211 are joined. By adding a fluorescent agent to the adhesive 244, the state of the hot melt after application can be confirmed.

Furthermore, hot melt generally has the characteristic that its color changes to brown when it deteriorates thermally. Hot melt that has changed color has a lower luminescence when irradiated with black light compared to normal hot melt. By detecting the degree of fermentation, the deterioration of the hot melt itself can be grasped, and application defects can be prevented. In addition, it is possible to measure the timing of equipment maintenance and replacement of deteriorated adhesive 244.

Another effect is that the adhesive 244 can be effectively removed when the cleaning recovery chamber or the cleaning container is reused. For example, when reusing a process cartridge, the cleaning recovery chamber 219 and the cleaning container 211 are once separated, and adhesive is applied again to join them. At this time, it is preferable to remove as much of the applied adhesive 244 as possible in order to rejoin them, and then join them with newly applied adhesive. However, it is difficult to visually check the remaining adhesive 244, and it is particularly difficult to check the adhesive remaining at the bottom of the groove 219a (see FIG. 25D).

Even in this case, by adding a fluorescent agent to the adhesive, it is possible to confirm the luminescence by irradiation with black light, and it is possible to reliably identify the residual area even with a small amount of adhesive. Therefore, the inclusion of a fluorescent agent is suitable for removal of the adhesive during reuse.

In this embodiment, the case where the cleaning recovery chamber and the cleaning container are joined has been described, but the same effect can be obtained by using the adhesive in the developing frame or the toner frame that stores the developer. The present invention can be applied to other locations in the above-mentioned embodiments, so long as the state is confirmed by adding a fluorescent substance to the adhesive. In particular, if the location is one where toner leakage may occur, such a configuration is effective in preventing leakage from the adhesive portion. The toner can be either toner before use or waste toner (waste developer) after use. For example, the present invention can be included in various components, such as a developing apparatus, a toner cartridge, a toner container, a process cartridge, and an image forming apparatus, including a developing container (toner container) that stores toner and is configured by joining multiple members with an adhesive. The present invention may also be used in an inspection after the developing container is integrally configured, or in a stage before one member is joined to the other member. The present invention can also be considered as a manufacturing method or an inspection method for a developing container that includes a process of inspection using a black light.

### Positioning of Toner Cartridge and Arrangement of Memory Tag

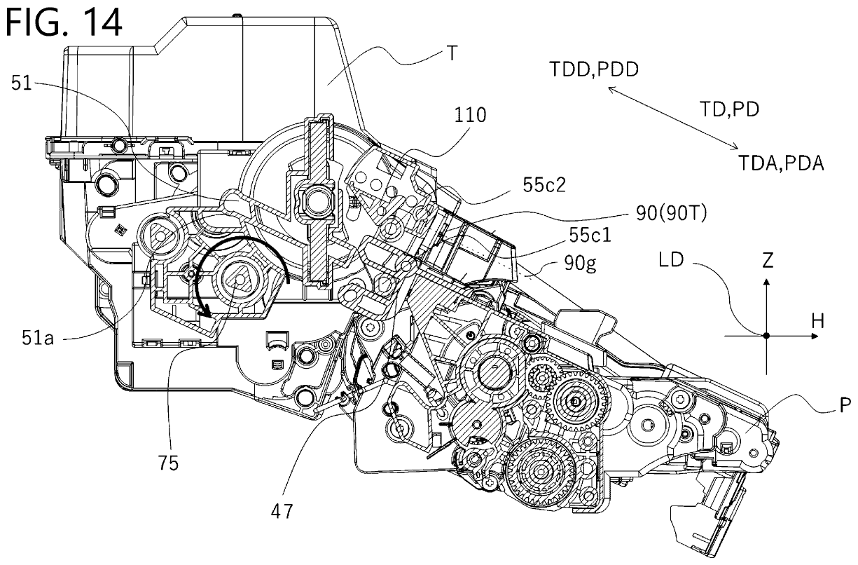

The relationship between the configuration regarding the positioning of the toner cartridge T and the arrangement of the memory tag 90T will be described. FIG. 14 is a cross-sectional view illustrating the attachment of the toner cartridge T to the process cartridge P. FIG. 23 is a cross-sectional view of the toner cartridge T attached to the apparatus body 100A, viewed from the driving side of the toner cartridge T. Note that some parts of the toner cartridge T have been omitted from the drawing.

The toner cartridge T has a positioned portion 55c1 that is positioned in the process cartridge P, and a force receiving portion 55c2 that is pressed by the apparatus body 100A. The positioned portion 55c1 and the force receiving portion 55c2 are projections that are arranged on the side of the toner frame 55 and protrude in the axial direction LD.

The process cartridge P has a toner cartridge positioning portion 47 that positions the toner cartridge T. The apparatus body 100A of the printer 100 further has a toner cartridge pressing portion 110 for holding the toner cartridge T in a predetermined position. The toner cartridge pressing portion 110 is pressed in a predetermined direction by a spring or the like.

As shown in FIG. 14, when the toner cartridge T is attached to the apparatus body 100A and the process cartridge P, the positioned portion 55c1 of the toner cartridge T abuts against the toner cartridge positioning portion 47 of the process cartridge P. As a result, the positioned portion 55c1 of the toner cartridge T is positioned in the attachment direction TDA. Additionally, in the direction perpendicular to the attachment direction TDA and vertically downward, the positioned portion 55c1 of the toner cartridge T abuts against the toner cartridge positioning portion 47 and is positioned.

The driving-side toner guide 51 is also provided with a driving-side rotation stopper 51a. The driving-side rotation stopper 51a abuts against the apparatus body 100A, and the toner cartridge T is prevented from rotating around the positioned portion 55c1.

When the toner cartridge T is driven by the apparatus body 100A, the first toner coupling 75 is driven counterclockwise in FIG. 14. As a result, a counterclockwise force acts on the toner cartridge T. When the toner cartridge T rotates counterclockwise, the positioned portion 55c1 moves away from the toner cartridge positioning portion 47, and the position of the toner cartridge T becomes unstable. Therefore, the force receiving portion 55c2 of the toner cartridge T is pressed by the toner cartridge pressing portion 110 of the apparatus body 100A, preventing the positioned portion 55c1 of the toner cartridge T from moving away from the toner cartridge positioning portion 47.

In the rotation direction of the first toner coupling 75, the force receiving portion 55c2 is disposed downstream of the positioned portion 55c1. The toner cartridge pressing portion 110 presses the force receiving portion 55c2 in the direction opposite to the direction in which the toner cartridge T rotates.

The above-mentioned configuration for pressing the toner cartridge T toward the process cartridge P is also provided on the non-driven side of the toner cartridge T. The configuration of the non-driven side is similar to the configuration of the driven side described above, so a description thereof will be omitted.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-065017, filed on Apr. 12, 2024, which is hereby incorporated by reference wherein in its entirety.

What is claimed is:

1. A container for storing a developer, comprising:
a first member;
a second member; and
a connection member configured to connect the first member and the second member, wherein
fluorescent agent is added to the connection member.

2. The container according to claim 1, wherein
at least part of the connection member is exposed to an outside of the container.

3. The container according to claim 1, wherein
the first member and the second member are joined to each other to form a storage section for storing a developer.

4. The container according to claim 2, wherein
a first joining section of the first member and a second joining section of the second member are joined by the connection member.

5. The container according to claim 4, wherein
one of the first joining section and the second joining section is a groove portion and the other is a protrusion portion, and
the groove portion and the protrusion portion are engaged in a state where the connection member is placed in the groove portion, thereby joining the first member and the second member.

6. The container according to claim 4, wherein
the connection member exposed to the outside of the container is located in a portion where joining surfaces of the first joining section and the second joining section are exposed to the outside of the container.

7. The container according to claim 4, wherein
the first joining section and the second joining section are each flat surfaces where the connection member is interposed therebetween and butted against the flat surfaces.

8. The container according to claim 1, wherein
the connection member is limonene.

9. The container according to claim 1, wherein
the connection member is hot melt.

10. The container according to claim 1, wherein
the fluorescent agent is added to the connection member at a ratio of 0.01 to 6.0 (wt %).

11. An inspection method for inspecting a container for storing a developer,
wherein the container comprises a first member, a second member, and a connection member connecting the first member and the second member, fluorescent agent is added to the connection member, the method comprising:
irradiating the container with light using a black light to detect the connection member exposed to an outside of the container.

12. An inspection method for inspecting a container for storing a developer,
wherein the container comprises a first member, a second member, and a connection member connecting the first member and the second member, fluorescent agent is added to the connection member, the method comprising:
in a state where the connection member is arranged on at least one of the first member and the second member, and before the first member and the second member are connected, irradiating the member on which the connection member is arranged among the first member and the second member with light from a black light to detect the connection member.

13. The inspection method according to claim 12, wherein
in the detecting step, an insufficient amount of application or overflow of the connection member is detected.
